(19) United States
(12) Patent Application Publication
(10) Pub. No.: US 2015/0116121 A1
(43) Pub. Date: Apr. 30, 2015

(54) VEHICLE SYSTEM, APPARATUS AND METHOD FOR CONTROLLING A VEHICLE

(71) Applicant: HYUNDAI MOTOR COMPANY, Seoul (KR)

(72) Inventors: Nam Woong Hur, Hwaseong (KR); Sin Gu Kim, Suwon (KR); Seul Ki Jeon, Gunsan (KR)

(21) Appl. No.: 14/509,368

(22) Filed: Oct. 8, 2014

(30) Foreign Application Priority Data
Oct. 31, 2013 (KR) 10-2013-0131155

(51) Int. Cl. G08B 21/24

(52) U.S. Cl. CPC G08B 21/24
USPC 340/686.6

(57) ABSTRACT

A vehicle system, an apparatus, and method for controlling a vehicle are provided. The vehicle system includes a wireless charging terminal that is configured to recognize whether a portable terminal is within a vehicle or an identification (ID) of the portable terminal via a communication channel with the portable terminal when the portable terminal is mounted on a charging cradle for wireless charging disposed within the vehicle. In addition, a controller is configured to receive the ID of the portable terminal or a mounted state of the portable terminal from the wireless charging terminal, collect information regarding an ignition of the vehicle or a state of a door, and output an alert signal in response to determining that the portable terminal is in the mounted state, when the ignition of the vehicle is turned off or the door is opened while the ignition of the vehicle is turned off.

### CROSS-REFERENCE TO RELATED APPLICATION

This application is based on and claims priority from Korean Patent Application No. 10-2013-0131155, filed on Oct. 31, 2013 in the Korean Intellectual Property Office, the disclosure of which is incorporated herein in its entirety by reference.

### BACKGROUND

1. Field of the Invention

The present invention relates to a vehicle system, an apparatus, and method for controlling a vehicle, and more particularly, to providing an alert for a portable terminal in a vehicle and operating a disposition of a device provided within a vehicle by automatically recognizing an identification (ID) of a portable terminal mounted to a charging cradle of a wireless charging terminal for the vehicle.

2. Description of the Prior Art

Generally a vehicle is used by one person or many people (e.g., family or members of a company and so on) use one vehicle by sharing. Additionally, a sitting height of each driver may be different causing a position of seat or mirror or the like to also be different. Therefore, each driver is required to adjust the position of seat or mirror etc. when the driver of the vehicle changes (or when a passenger is in the passenger seat) for personalized seat comfort. The position of seat or mirror etc. of each driver may be set appropriately for each driver using an intelligent memory system (IMS).

The IMS includes a setting scheme which may be set by a driver to record a particular seating adjustment or mirror adjustment, however the number of a different settings capable of being stored is restrictive. Further, another setting program includes recognizing the driver using local area communication with a wireless communication device. However, such a setting program has increased costs due to the combined wireless communication technology and malfunction to wireless communication may occur.

### SUMMARY

Accordingly, the present invention provides a vehicle system, an apparatus, and method for controlling a vehicle to adjust a posture (e.g., a position and angle) of a seat, an interior mirror, a side mirror, and the like by automatically recognizing an identification (ID) of a portable terminal mounted to a charging cradle of a wireless charging terminal for vehicle without additionally operating a switch. In addition, the present invention provides a vehicle system, an apparatus, and method for controlling a vehicle to enable the driver or other passenger to recognize the mounted state of the portable terminal by outputting an alert when the ignition of the vehicle is turned off, when the door is opened, and when the portable terminal is mounted within the vehicle.

In order to achieve the above objects, a vehicle system according to an exemplary embodiment of the present invention may include a wireless charging terminal configured to recognize whether a portable terminal is within a vehicle or an identification (ID) of the portable terminal via a communication channel with the portable terminal when the portable terminal is mounted on a charging cradle for wireless charging disposed within the vehicle; and a controller configured to receive the ID of the portable terminal or a mounted state of the portable terminal from the wireless charging terminal, collect information for an ignition of the vehicle or a state of a door, and output an alert signal in response to determining that the portable terminal is in the mounted state, when the ignition of the vehicle is turned off, or the door is opened while the ignition of the vehicle is turned off.

The vehicle system may further include a posture adjustment apparatus configured to adjust a position for at least one unit of a seat, a handle, an interior mirror, and a side mirror disposed within the vehicle based on a control signal output from the controller, or adjust contents of a multimedia system, an air conditioning system, and a display, based on a setting value that corresponds the ID of the portable terminal received from the wireless charging terminal.

Further, to achieve the above objects, an apparatus for controlling a vehicle according to an exemplary embodiment of the present invention may include a communicator configured to receive an ID of a portable terminal or information regarding a mounted state of the portable via a communication channel with the portable terminal mounted on a charging cradle from the wireless charging terminal within a vehicle; an ID recognizer configured to recognize the ID of the portable terminal received via the communicator; an information collector configured to collect state information of the vehicle for when an ignition of the vehicle is turned on or off or when a door is opened or closed; a signal processor configured to execute an alert output based on the collected state information of the vehicle or the mounted state of the ID recognized portable terminal; and a output configured to output an alert based on the control of the signal processor.

The signal processor may be configured to output a first alert signal in response to determining that the portable terminal is in a mounted state when the ignition of the vehicle is turned off, and may be configured to output a first alert that corresponds to the first alert signal. In addition, the signal processor may be configured to output via the output a second alert signal in response to determining that the portable terminal is in the mounted state when the ignition of the vehicle is turned off and the door is opened, and may be configured to output a second alert via the output that corresponds to the second alert signal. The ID recognizer may be configured to store the ID of the portable terminal in a memory in response to determining whether the recognized ID of the portable terminal is a pre-registered ID in a memory.

The control apparatus may further include a memory controller configured to provide a setting value that corresponds to the ID of the portable terminal by accessing a setting value for each ID registered in a memory when the ID of the portable terminal is recognized; and a posture controller configured to output a control signal that adjusts a position for at least one unit of a seat, a handle, an interior mirror, and a side mirror disposed within the vehicle or extraneous to the vehicle (e.g., the side mirror), or may be configured to adjust contents of the multimedia system, an air conditioning system, and a display disposed within the vehicle, based on the setting value that corresponds to the ID of the portable terminal.

When a position of the unit disposed within the vehicle is manually adjusted, the posture controller may have the setting value of the manually adjusted unit stored in a memory that corresponds to the ID of the portable terminal. When an ignition of the vehicle is turned off, the posture controller may have a position of the unit disposed within the vehicle initiated by outputting a control signal that corresponds to a pre-set default value.

In order to achieve the above objects, a method for controlling a vehicle according to an exemplary embodiment of the present invention may include: receiving an ID of a portable terminal or information regarding an mounted state of the portable via a communication channel with the portable terminal mounted on a charging cradle from the wireless charging terminal within a vehicle; recognizing the received ID of the portable terminal; collecting state information of the vehicle for when an ignition of the vehicle is turned on/off or when a door is opened or closed; outputting an alert signal which adjusts an alert output according to the collected state information of the vehicle or the mounted state of the ID recognized portable terminal; and outputting an alert that corresponds to the alert signal.

According to the present invention, a posture (e.g., a position and angle) of a seat, an interior mirror, a side mirror, etc. may be adjusted by automatically recognizing ID of a portable terminal mounted to a charging cradle of a wireless charging terminal for vehicle without additionally operating a switch, thus improving user convenience. In addition, according to the present invention, the driver or other passengers may be able to recognize the mounted state of the portable terminal by being notified via an alert regarding the state of when the ignition of the vehicle is turned off, when the door is opened, and when the portable terminal is mounted within the vehicle.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary block diagram illustrating composition of a vehicle system according to an exemplary embodiment of the present invention;

FIG. 2 is an exemplary block diagram illustrating composition of a control apparatus of a vehicle according to an exemplary embodiment of the present invention;

FIG. 3 is an exemplary diagram illustrating signal flow between a wireless charging terminal and a control apparatus of a vehicle according to an exemplary embodiment of the present invention;

FIG. 4 is an exemplary diagram illustrating signal flow between a wireless charging terminal and a control apparatus of a vehicle according to another exemplary embodiment of the present invention; and

FIG. 5 is an exemplary diagram illustrating signal flow between a control apparatus and an adjustment apparatus of a vehicle according to an exemplary embodiment of the present invention;

FIG. 6 and FIG. 7 are exemplary flow charts illustrating operation flow in relation to a control method of a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit/control apparatus refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit/control apparatus or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings.

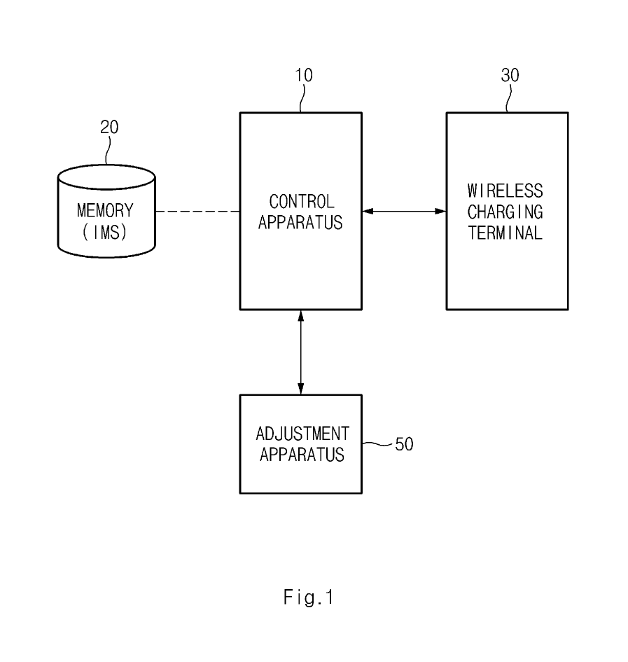

FIG. 1 is an exemplary block diagram illustrating composition of a vehicle system according to an exemplary embodiment of the present invention. Referring to FIG. 1, the vehicle system according to an exemplary embodiment of the present invention may include a control apparatus 10, a wireless charging terminal 30 and an adjustment apparatus 50. The control apparatus 10 may be configured to operate the wireless charging terminal 30 and the adjustment apparatus 50. Further, the vehicle system may include a memory (Intelligent Memory System, IMS) 20 in which a posture setting value (hereinafter called ‘setting value’) may be stored. In FIG. 1, the memory 20 implemented extraneous to the control apparatus 10 is shown, but the memory 20 may be mounted within memory implemented inside the control apparatus 10. The control apparatus 10 may be configured to recognize an ID of a corresponding portable terminal by receiving an ID of the portable terminal from the wireless charging terminal 30.

Herein, the wireless charging terminal 30 may be configured to receive information regarding the portable terminal via the communication channel established between the wireless charging terminal and the portable terminal, when the portable terminal is mounted to a charging cradle, to allow the charging terminal to recognize the ID of the portable terminal. The wireless charging terminal 30 may be configured to transmit the ID of the portable terminal to the control apparatus 10 via internal network of a vehicle, e.g. control area network (CAN) communication, when the ID of the mounted portable terminal is recognized. Further, the wireless charging terminal 30 may be configured to transmit information regarding a mount state of the portable terminal to the control apparatus 10 via internal network of the vehicle based on whether the portable terminal is mounted to the charging cradle.

The control apparatus 10 may be configured to collect/obtain state information regarding the vehicle, for example, the state in which the ignition of the vehicle is turned on or off, and the state in which the door is opened or closed, when the ID and the information for the mounted state of the portable terminal is received from the wireless charging terminal 30. Further, the control apparatus 10 may be configured to output an alert based on the state of the vehicle and the mounted state of the portable terminal. As an example, the control apparatus 10 may enable the driver or other passengers within the vehicle to recognize the mounted state of the portable terminal by outputting an alert signal, when the ignition of the vehicle is turned off or the door is opened while the ignition of the vehicle is turned off.

Additionally, the control apparatus 10 may be configured to manage the setting value for the posture of at least one unit disposed within the vehicle, for example, a position, an angle, etc. that corresponds to the recognized portable terminal. In other words, the control apparatus 10 may be configured to register or store the ID of the portable terminal first recognized to the memory 20, store the setting value regarding the posture of the corresponding unit to correspond to an ID of the corresponding portable terminal when at least one unit disposed within the vehicle is manually adjusted. Herein, the at least one unit disposed within the vehicle may be a seat, a handle, an interior mirror and a side mirror etc., otherwise may be any unit relevant to adjusting a posture according to a driver. Therefore, when the ID of the portable terminal pre-registered in the memory 20 is recognized, the control apparatus 10 may be configured to operate the adjustment apparatus 50 to adjust the posture for at least one unit disposed within the vehicle according to a setting value stored corresponding to the recognized portable terminal.

The adjustment apparatus 50 may be configured to adjust the posture of the at least one unit disposed within the vehicle based on the control of the control apparatus 10. In other words, when the adjustment apparatus 50 receives a control signal that corresponds to the setting value of at least one unit among a seat, a handle, an interior mirror, and a side mirror from the control apparatus 10, the adjustment apparatus 50 may be configured to adjust a position or angle of the at least one among the seat, the handle, the interior mirror, and the side mirror based on the received control signal.

Further, when the posture of the at least one unit disposed within the vehicle is adjusted by the driver, the adjustment apparatus 50 may be configured to transmit the setting value of the unit of which the posture is adjusted by the driver to the control apparatus 10 via internal network of the vehicle. Therefore, the control apparatus 10 may be configured to update a stored setting value corresponding to the ID of the portable terminal to the memory 20 based on the setting value received from the adjustment apparatus 50.

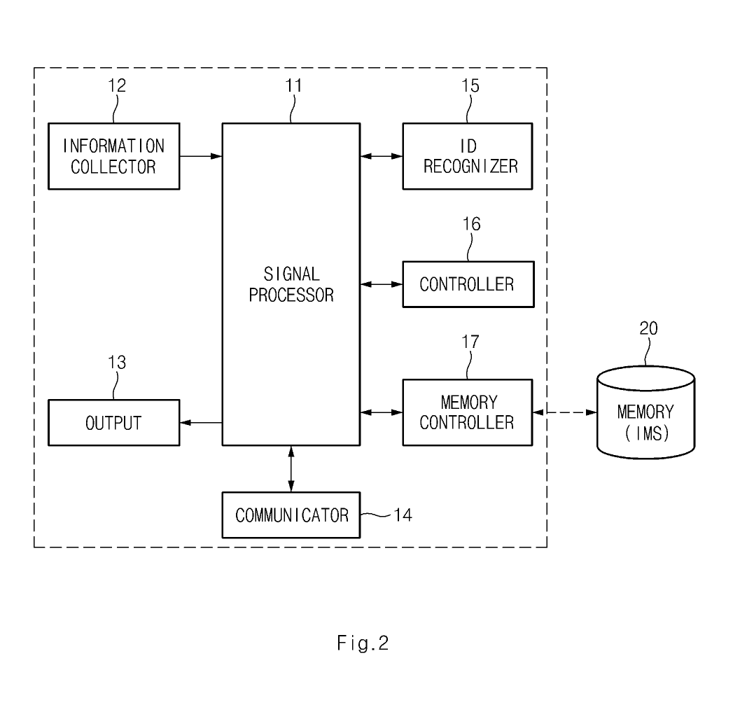

Hereinafter, a detailed composition of the control apparatus 10 will be described with reference to FIG. 2. FIG. 2 is an exemplary block diagram illustrating composition of a control apparatus of a vehicle according to an exemplary embodiment of the present invention. Referring to FIG. 2, the control apparatus 10 according to an exemplary embodiment of the present invention may include a signal processor 11, an information collector 12, an output 13, a communicator 14, an ID recognizer 15, a controller 16, and a memory controller 17. Herein, the signal processor 11 may be configured to process the signal transmitted to each unit of a control apparatus 10.

The information collector 12 may be configured to obtain state information regarding a vehicle. For example, the information collector 12 may be configured to obtain a starting on or off state, a door open or closed state of the vehicle and on the like. The output 13 may include a display such as a monitor, a navigator etc. disposed within the vehicle, and may include a sound output such as a speaker, a buzzer and the like. Further, the output 13 may include an alert lamp. At the output 13, information according to the state information and operation of the control apparatus 10 may be output. Additionally, the output 13 may be configured to output an alert based on an alert signal output from the signal processor 11 based on whether a portable terminal is mounted within the vehicle. The portable terminal may be configured to charge a battery by receiving charging electric power from a charging terminal 30. Herein, the output 13 may be configured to output the alert signal as a blinking lamp and may be configured to display an alert message at screen or output an alert sound via a speaker or a buzzer.

The communicator 14 may include communication module that supports communication interface for signal transmitting and receiving between each apparatus within the vehicle. For example, the communicator 14 may include a CAN module that supports CAN communication within the vehicle. In addition, the communicator 14 may be configured to receive the ID of the portable terminal and the information regarding the mounted state of the portable terminal from the wireless charging terminal 30 via the communication channel with the portable terminal mounted on the charging cradle. When the ID information of the portable terminal is received from the wireless charging terminal 30 via the communicator 14, the ID recognizer 15 may be configured to recognize the ID of the corresponding portable terminal. Accordingly, the ID recognizer 15 may be configured to determine whether the recognized ID of the portable terminal is the pre-registered to the memory 20. When the ID of the corresponding portable terminal is not the pre-registered ID, the ID may be registered to the memory 20.

When a setting value is received from the adjustment apparatus via the communicator 14, the controller 16 may be configured to receive a setting value stored to the memory 20 corresponding to the ID of the portable terminal recognized by the ID recognizer 15. When the setting value corresponding to the ID of the corresponding portable terminal is not stored in the memory 20, the controller 16 may be configured to receive a setting value stored based on the ID of the corresponding portable terminal. Meanwhile, when the setting value that is stored corresponding to the ID of the corresponding portable terminal, the controller 16 may be configured to update the setting value previously stored corresponding to the ID of the corresponding portable terminal. In particular, the setting value may be updated to a setting value received from the adjustment apparatus.

Further, when the ID of the portable terminal is recognized by the ID recognizer 15, the controller 16 may be configured to extract the setting value corresponding to the ID of the corresponding portable terminal among a setting value for each ID stored in the memory 20. The controller 16 may be configured to generate a control signal to adjust the posture of at least one unit disposed within the vehicle based on the extracted setting value to output the control signal to the adjustment apparatus. For example, when the setting value of the seat and interior mirror corresponding to the ID of portable terminal 1 is stored, the controller 16 may be configured to output a control signal to the adjustment apparatus by generating the control signal to adjust a posture of the seat and interior mirror adjusted according to the setting value of the seat and interior mirror corresponding to the ID of the portable terminal 1 extracted from the memory 20.

Moreover, when information regarding the starting off state of the vehicle is gathered by the information collector 12, the controller 16 may be configured to output a control signal to the adjustment apparatus by generating the control signal corresponding to a default value regarding the posture of each unit disposed within the vehicle. The adjustment apparatus may be configured to initialize the posture of the each unit based on the control signal corresponding to the default value output by the controller 16. For example, the adjustment apparatus may be configured to adjust a back of the seat to a highest angle based on a control signal that corresponds to a default value, and adjust a position of the seat to a nearest position from a back seat.

The memory controller 17 may be configured to manage the memory 20. For example, when the ID is recognized by the ID recognizer 15, the memory controller 17 may be configured to provide information regarding pre-registered ID to the ID recognizer 15 by recalling (e.g., accessing) the memory 20 based on a request of the ID recognizer 15. Additionally, the memory controller 17 may be configured to provide a stored setting value corresponding to the ID of the portable terminal recognized by the ID recognizer 15 to the controller 16 by recalling the memory 20 based on a request of the controller 16. Further, the memory controller 17 may be configured to store the ID of the portable terminal to the memory 20 based on a request of the ID recognizer 15, store a setting value corresponding to ID of the portable terminal based on request of the controller 16, or update a setting value previously stored.

Furthermore, the signal processor 11 may be configured to execute an alert output based on a vehicle state and a mounted state of the portable terminal. When information of the starting off state is gathered by the information collector 12, the signal processor 11 may be configured to recognize information regarding the mount state of the portable terminal received from the wireless charging terminal 30. When the state in which the portable terminal is mounted is recognized in the starting off state, the signal processor 11 may be configured to output to the output 13 a first alert signal to have a first alert output. In particular, the output 13 may have an LED lamp blink to correspond to the first alert signal.

In outputting the first alert signal, the signal processor 11 may be configured to provide a notification as to whether a door of the vehicle is in an open state. In response to recognizing that the door of the vehicle is in the open state and the portable terminal is in the mount state in the state of outputting the first alert signal, the signal processor 11 may be configured to output a second alert signal to have a second alert output to the output 13. In particular, the output 13 may be configured to output a guide sound or an alert sound to provide a notification that the portable terminal is in the mount state via a buzzer etc. to allow the mount state of the portable terminal to be recognized by a driver or other passengers.

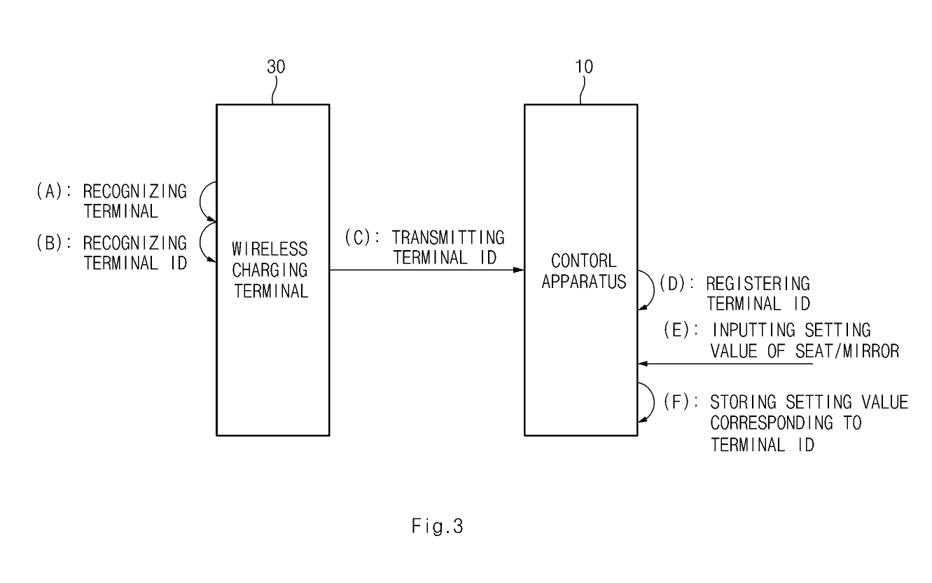

FIG. 3 is an exemplary diagram illustrating signal flow between a wireless charging terminal and a control apparatus of a vehicle according to an exemplary embodiment of the present invention. Referring to FIG. 3, when a portable terminal is mounted to a charging cradle, a wireless charging terminal 30 may be configured to recognize that the terminal is mounted as show in (a), after that, recognize the ID of the portable terminal as shown in (b) by transmitting and receiving signal with the portable terminal via the communication channel.

Accordingly, when the ID of the portable terminal mounted to the charging cradle is recognized as shown in (b), the wireless charging terminal 30 may be configured to transmit the ID of the recognized portable terminal to a control apparatus 10 as shown in (c). In particular, the wireless charging terminal 30 may be configured to transmit the ID of the portable terminal to the control apparatus 10 using internal network of a vehicle, e.g. CAN communication. When the ID of the portable terminal is received through (c), the control apparatus 10 may be configured to register the received ID of the portable terminal as shown in (d). Herein, it may be assumed that the ID of the portable terminal received through (c) is the ID of the portable terminal received first from the wireless charging terminal 30.

After that, when the posture of the seat and mirror etc. is adjusted by a driver, the control apparatus 10 may be configured to input a setting value of the seat and mirror as shown in (e). The control apparatus 10 may then be configured to store the setting value of the seat and mirror as shown in (f) to correspond to the ID of the portable terminal registered at (d).

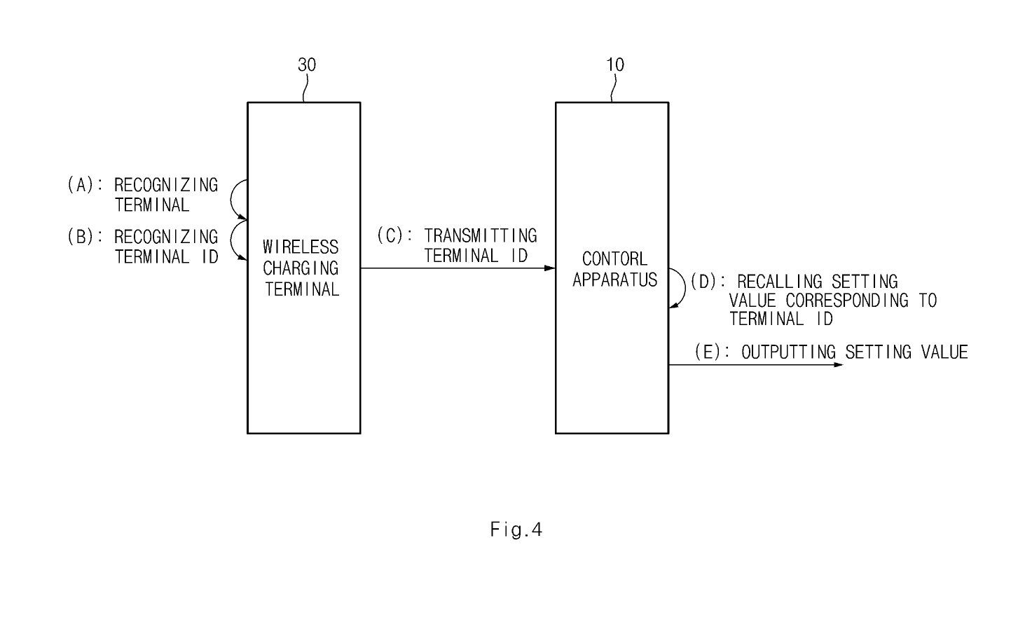

FIG. 4 is an exemplary diagram illustrating signal flow between a wireless charging terminal and a control apparatus of a vehicle according to another exemplary embodiment of the present invention. Referring to FIG. 4, when a portable terminal is mounted to a charging cradle, a wireless charging terminal 30 may be configured to recognize that the terminal is mounted as shown in (a), after that, recognize the ID of the portable terminal as shown in (b) by transmitting and receiving signal with the portable terminal via a charging socket and so on.

When the ID of the portable terminal mounted to the charging cradle is recognized as shown in (b), the wireless charging terminal 30 may be configured to transmit the ID of the recognized portable terminal to a control apparatus 10 as shown in (c). In particular, the wireless charging terminal 30 may be configured to transmit the ID of the portable terminal to the control apparatus 10 using internal network of a vehicle, e.g. CAN communication. The control apparatus 10 may be configured to receive the ID of the portable terminal through (c). Herein, it may be assumed that the ID of the portable terminal received through (c) is the ID of the portable terminal pre-registered in a memory. Thus, the control apparatus 10 may be configured to access a setting value stored corresponding to the ID of the portable terminal received as shown in (d). The control apparatus 10 may then be configured to output the setting value accessed at (d) as shown in (e)

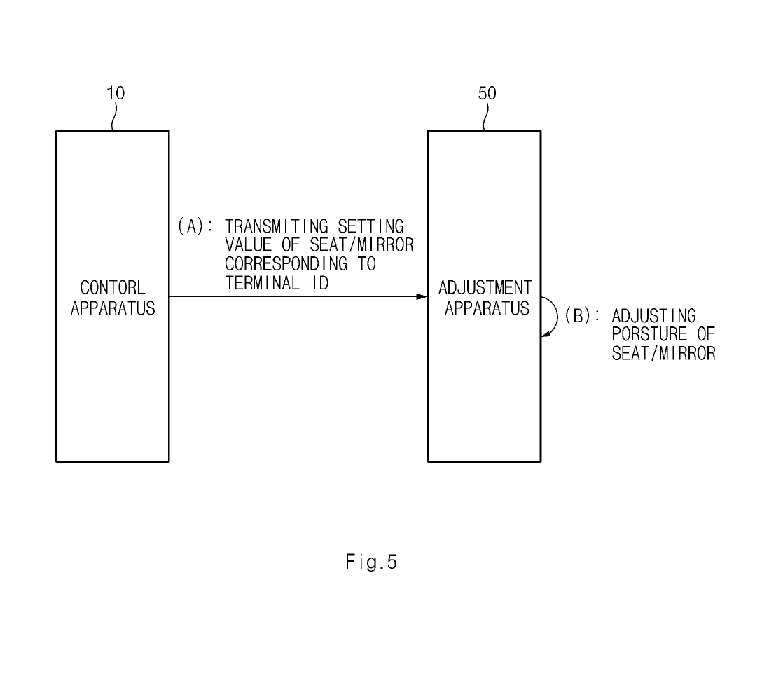

FIG. 5 is an exemplary diagram illustrating signal flow between a control apparatus and an adjustment apparatus of a vehicle according to an exemplary embodiment of the present invention. Referring to FIG. 5, when the ID of a portable terminal is received via a wireless charging terminal, the control apparatus 10 may be configured to transmit a setting value of the seat and mirror corresponding to the ID of the portable terminal to the adjustment apparatus 50 as shown in (a). Herein, the control apparatus 10 may be configured to transmit the setting value of the seat and mirror to the adjustment apparatus 50 using internal network in a vehicle, e.g. CAN communication. Therefore, the adjustment apparatus 50 may be configured to adjust the posture of the seat and mirror of the corresponding vehicle according to the setting value of seat and mirror transmitted at (a).

Thus, a vehicle system according to an exemplary embodiment of the present invention may automatically recognize the ID of the portable terminal to adjust the posture of corresponding unit based on a setting value stored corresponding to the ID of the portable terminal by merely mounting the portable terminal to a charging cradle, without additionally operating a switch by a driver.

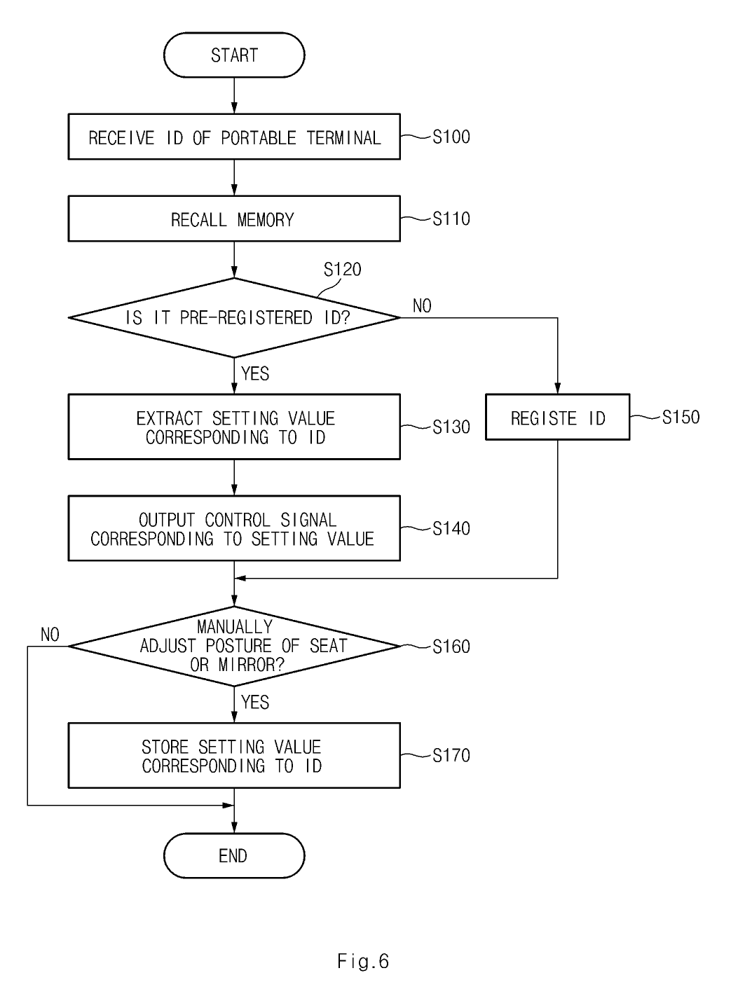

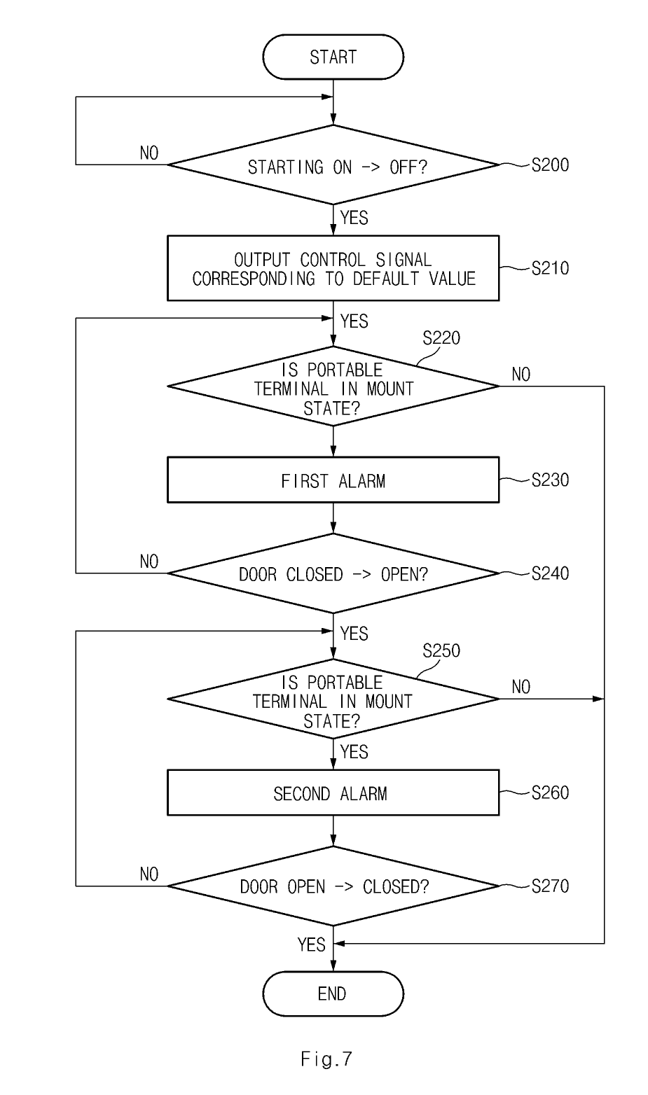

A control apparatus according to an exemplary embodiment of the present invention, composed as described above, will be explained further in detail as below. FIG. 6 and FIG. 7 are exemplary flow charts illustrating operation flow in relation to a control method of a vehicle according to an exemplary embodiment of the present invention. At first, FIG. 6 shows an operation flow for storing a setting value corresponding to the ID of a portable terminal and adjusting posture. As shown in FIG. 6, when the ID of the portable terminal is received from a wireless charging terminal S100, the control apparatus may be configured to access a memory in which a setting value corresponding to each ID of the portable terminal may be stored S110.

At step S100 the control apparatus may be configured to determine whether the ID of the portable terminal is the ID pre-registered in the memory, at step S120 when the ID of the corresponding portable terminal is ID pre-registered in the memory, at step S130 the control apparatus may be configured to extract the setting value stored corresponding to the ID of the corresponding portable terminal from the memory accessed at step S110. The control apparatus may be configured to output a control signal that corresponds to the setting value extracted at step S130 to the adjustment apparatus S140. Therefore, the adjustment apparatus may be configured to store the posture, for example, a position, an angle, etc. for at least one unit of a seat, a handle, an interior mirror, and a side mirror according to the control signal output at step S140. Additionally, when the posture for a position, an angle, etc. of at least one of a seat, a handle, an interior mirror, and a side mirror is manually adjusted by driver, etc. S160, the control apparatus may be configured to adjust a setting value stored to the memory corresponding to the ID of the corresponding portable terminal by receiving the setting value manually adjusted from the adjustment apparatus S170.

Meanwhile, at step S120 when the ID of the portable terminal is not a ID pre-registered in the memory, the control apparatus may be configured to register the ID of the corresponding portable terminal to the memory S150. After that, when the posture of at least one of a seat, a handle, an interior mirror, etc. is manually adjusted by driver, etc. S160, at S170 the control apparatus may be configured to store a setting value to the memory corresponding to the ID of the corresponding portable terminal by receiving the setting value that is manually adjusted from the adjustment apparatus.

FIG. 7 shows the exemplary control and alert operation when the ignition of the vehicle is turned off. As shown in FIG. 7, when a starting state of the vehicle is changed from ON state to OFF state S200, the control apparatus may be configured to generate a control signal that corresponds to a pre-registered default value and output the control signal to the adjustment apparatus S210.

The adjustment apparatus may be configured initiate the posture for a position, an angle, etc. of at least one of a seat, a handle, an interior mirror, according to the control signal output at step S210. Further, when the vehicle is in the state in which the ignition of the vehicle is turned off at step S200, the adjustment apparatus may be configured to determine whether the portable terminal is in a mount state based on information regarding the mount state of the portable terminal provided from the wireless charging terminal. In response to determining that the portable terminal remains in the mount state S220, the control apparatus may be configured to perform a first alert such as blinking a lamp, etc. S230.

In response to determining that the portable terminal is not in the mount state before a door state of the vehicle is turned to an open state during the first alert output at step S230, the control apparatus may be configured to terminate related operation. Further, when a door state of the vehicle is changed from a closed state to the open state during the first alert output at step S230 S240, when the portable terminal remains in the mount state by confirming the mounted state of the portable terminal S250, the control apparatus may be configured to perform a second alert such as outputting an alert sound, etc. S260. The control apparatus may be configured to output the second alert until the door state of the vehicle is changed from the open state to the closed state, in response to determining that the portable terminal is not in the mount state during the second alert, the control apparatus may be configured to terminate related operation.

The above description is merely for describing the spirit of the invention by way of examples thereof, modification and changes for the contents described previously may be possible without departing from the spirit and scope of the present invention by one of ordinary skill in the related art in that the present invention is included. Therefore, the described exemplary embodiments should be considered in a descriptive sense only and not for purpose of limitation for the spirit of the present invention. The scope of the present invention will be construed by the appended claims, and all the technical spirit within the equivalent scope of the present invention will be construed as being included in the present invention.

What is claimed is:

1. A vehicle system, comprising:
a wireless charging terminal configured to recognize whether a portable terminal is within a vehicle or an identification (ID) of the portable terminal via a communication channel with the portable terminal when the portable terminal is mounted on a charging cradle for wireless charging disposed within the vehicle; and
a controller configured to receive the ID of the portable terminal or a mounted state of the portable terminal from the wireless charging terminal, collect information regarding an ignition of the vehicle or a state of a door, and output an alert signal in response to determining that the portable terminal is in the mounted state, when the ignition of the vehicle is turned off, or the door is opened while the ignition of the vehicle is turned off.

2. The vehicle system according to claim 1, wherein the controller is further configured to adjust a position for at least one unit of a seat, a handle, an interior mirror, and a side mirror disposed within the vehicle, or adjust contents of a multimedia system, an air conditioning system, and a display, according to a setting value corresponding the ID of the portable terminal received from the wireless charging terminal.

3. An apparatus for controlling a vehicle, comprising:
a memory configured to store program instructions; and
a processor configured to execute the program instructions, the program instructions when executed configured to:
receive an identification (ID) of a portable terminal or information regarding a mounted state of the portable via a communication channel with the portable terminal mounted on a charging cradle from the wireless charging terminal within a vehicle;
recognize the received ID of the portable terminal received;
collect state information of the vehicle regarding a in state which an ignition of the vehicle is turned on/off or a state in which a door is opened or closed;
execute an alert output signal according to the collected state information of the vehicle or the mounted state of the ID recognized portable terminal; and
output an alert based on the alert output signal.

4. An apparatus for controlling a vehicle according to claim 3, wherein the program instructions when executed are further configured to output a first alert signal in response to determining that the portable terminal is in the mounted state when the ignition of the vehicle is turned off, and output a first alert that corresponds to the first alert signal.

5. An apparatus for controlling a vehicle according to claim 3, wherein the program instructions when executed are configured to output a second alert signal in response to determining that the portable terminal is in the mounted state when the ignition of the vehicle is turned off and the door is opened, and output a second alert that corresponds to the second alert signal.

6. An apparatus for controlling a vehicle according to claim 3, wherein the program instructions when executed are configured to register the ID of the portable terminal to the memory in response to determining whether the recognized ID of the portable terminal is a pre-registered ID in the memory and the recognized ID is not the pre-registered ID.

7. An apparatus for controlling a vehicle according to claim 3, wherein the program instructions when executed are further configured to:
provide a setting value that corresponds to the ID of the portable terminal by accessing a setting value for each ID registered in the memory when the ID of the portable terminal is recognized; and
output a control signal that adjusts a position for at least one unit of a seat, a handle, an interior mirror, and a side mirror disposed the vehicle, or adjust contents of the multimedia system, an air conditioning system, and a display disposed within the vehicle, based on the setting value that corresponds to the ID of the portable terminal.

8. An apparatus for controlling a vehicle according to claim 7, wherein when a position of the unit disposed within the vehicle is manually adjusted, the program instructions when executed are further configured to store the setting value of the manually adjusted unit to correspond to the ID of the portable terminal.

9. An apparatus for controlling a vehicle according to claim 7, wherein when an ignition of the vehicle is turned off, the program instructions when executed are further configured to initiate a position of the unit disposed within the vehicle by outputting a control signal that corresponds to a pre-set default value.

10. A method for controlling a vehicle, comprising:
receiving, by a controller, an identification (ID) of a portable terminal or information regarding a mounted state of the portable via a communication channel with the portable terminal mounted on a charging cradle from the wireless charging terminal within a vehicle;
recognizing, by the controller, the received ID of the portable terminal;
collecting, by the controller, state information of the vehicle regarding a state in which an ignition of the vehicle is turned on/off or a state in which a door is opened or closed;
outputting, by the controller, an alert signal which executes an alert output based on the collected state information of the vehicle or the mounted state of the ID recognized portable terminal; and
outputting, by the controller, an alert that corresponds to the alert signal.

11. A method for controlling a vehicle according to claim 10, wherein the outputting of an alert signal includes:
outputting, by the controller, a first alert signal to output a first alert in response to determining that the portable terminal is in the mounted state when the ignition of the vehicle is turned off; and
outputting, by the controller, a second alert signal to output a second alert in response to determining that the portable terminal is in the mounted state when the ignition of the vehicle is turned off and the door is opened.

12. A method for controlling a vehicle according to claim 10, wherein the method further includes:
obtaining, by the controller, a setting value that corresponds to the ID of the portable terminal by accessing a setting value for each ID registered in a memory when the ID of the portable terminal is recognized; and
adjusting, by the controller, a position for at least one unit of a seat, a handle, an interior mirror, and a side mirror disposed within the vehicle based on an output control signal, or adjusting contents of a multimedia system, an air conditioning system, and a display, based on a setting value that corresponds the ID of the portable terminal received from the wireless charging terminal.

13. A method for controlling a vehicle according to claim 11, wherein when a position of the unit disposed within the vehicle is manually adjusted, the method further includes:
storing, by the controller, a setting value of the manually adjusted unit to correspond to the ID of the portable terminal.
